(19) United States
(12) Patent Application Publication
(10) Pub. No.: US 2026/0086331 A1
(43) Pub. Date: Mar. 26, 2026

(54) OPTICAL SYSTEM AND IMAGING APPARATUS

(71) Applicant: Tamron Co., Ltd., Saitama (JP)

(72) Inventor: Tomohiro KOBAYASHI, Saitama (JP)

(73) Assignee: Tamron Co., Ltd., Saitama (JP)

(21) Appl. No.: 19/301,612

(22) Filed: Aug. 15, 2025

(30) Foreign Application Priority Data
Sep. 24, 2024 (JP) 2024-164765

(51) Int. Cl. G02B 13/00; G02B 7/02; H04N 23/55

(52) U.S. Cl. CPC G02B 13/0045; G02B 7/025; G02B 13/006; H04N 23/55

(57) ABSTRACT

An optical system includes: a first lens group; and a rear group that has a plurality of lens groups, the first lens group and the rear group being arranged in order from an object side, wherein a spacing between lens groups which are adjacent to each other changes during focusing, the rear group includes a first focus group which has a negative refractive power and moves during focusing, and a second focus group which has a negative refractive power and moves during focusing, at least one lens group P having a positive refractive power is provided between the first focus group and the second focus group, the lens group P includes a subgroup PN having a negative refractive power at a position closest to the object side, and predetermined conditional formulae are satisfied. An imaging apparatus includes: the optical system, and an image sensor.

### CROSS-REFERENCE TO RELATED APPLICATIONS

This application is based on and claims the benefit of priority from Japanese Patent Application No. 2024-164765, filed on Sep. 24, 2024, the entire contents of which are incorporated herein by reference.

### BACKGROUND OF THE INVENTION

### Technical Field

The present invention relates to an optical system and an imaging apparatus. More specifically, the present invention relates to, for example, an optical system and an imaging apparatus suitable for use in imaging optical systems of digital input and output apparatuses, such as digital still cameras and digital video cameras using solid-state image sensors, etc.

### Related Art

Recently, imaging apparatuses, such as digital still cameras, using solid-state image sensors have been increasingly widespread. This tendency has been followed by the performance improvement and downsizing of optical systems, and compact imaging apparatus systems have rapidly become widespread. Furthermore, in optical systems capable of close-up imaging with high magnification, high optical performance is required from infinity to the minimum object distance. Accordingly, a so-called floating system, in which aberration fluctuations are suppressed by moving a plurality of lens groups during focusing, is being adopted.

JP 2015-215392 A and JP 2020-064123 A disclose inventions of macro lenses which include a first to fifth lens groups having positive, negative, positive, negative, and positive refractive powers, respectively, wherein the second lens group and the fourth lens group perform floating.

However, in an optical system adopting a floating system, when the weight of each focus group required during focusing is large, it leads to an increase in the size of the optical system and the lens barrel.

In the optical systems according to JP 2015-215392 A and JP 2020-064123 A, the number of lenses in the second lens group is large, and the weight of lenses in the second lens group is heavy, and thus, downsizing and weight reduction are insufficient. In addition, the lens group on the image side of the focus group is large, resulting in insufficient downsizing and weight reduction of the overall product.

Accordingly, an object of the present invention is to provide a compact optical system and a compact imaging apparatus having high optical performance from infinity to the minimum object distance.

### SUMMARY OF THE INVENTION

In order to solve the above-described problem, the optical system according to the present invention includes:
a first lens group; and a rear group that has a plurality of lens groups, the first lens group and the rear group being arranged in order from an object side, wherein
during focusing, a spacing between lens groups which are adjacent to each other changes,
the rear group includes a first focus group which has a negative refractive power and moves during focusing, and a second focus group which has a negative refractive power and moves during focusing,
at least one lens group P having a positive refractive power is provided between the first focus group and the second focus group,
the lens group P includes a subgroup PN having a negative refractive power at a position closest to the object side, and
the following conditional formulae are satisfied:

$$0.3 < \vert fP / fPN \vert \qquad ( 1 )$$

$$0.05 < \vert ( 1 - β f 1 \times β f 1 ) \times β f 1 r \times β f 1 r \vert / Fno < 2. \qquad ( 2 )$$

here,
fP is a focal length of the lens group P,
fPN is a focal length of the subgroup PN,
βf1 is a lateral magnification of the first focus group at infinity focus,
βf1r is a lateral magnification at infinity focus of all lenses arranged on an image side of the first focus group, and
Fno is an open F-number of the entire system at infinity focus.

To solve the problem, an imaging apparatus according to the present invention includes the aforementioned optical system and an image sensor that converts an optical image formed by the optical system into an electrical signal.

### Effect of the Invention

According to the present invention, it is possible to provide a compact optical system and a compact imaging apparatus having high optical performance from infinity to the minimum object distance.

### BRIEF DESCRIPTION OF THE DRAWINGS

FIG. 1 is a sectional view of an optical system in Example 1 of the present invention;

FIG. 2 is a diagram illustrating various aberrations of the optical system in Example 1 at infinity focus;

FIG. 3 is a diagram illustrating various aberrations of the optical system in Example 1 at minimum object distance focus;

FIG. 4 is a sectional view of an optical system in Example 2 of the present invention;

FIG. 5 is a diagram illustrating various aberrations of the optical system in Example 2 at infinity focus;

FIG. 6 is a diagram illustrating various aberrations of the optical system in Example 2 at minimum object distance focus;

FIG. 7 is a sectional view of an optical system in Example 3 of the present invention;

FIG. 8 is a diagram illustrating various aberrations of the optical system in Example 3 at infinity focus;

FIG. 9 is a diagram illustrating various aberrations of the optical system in Example 3 at minimum object distance focus; and

FIG. 10 is a diagram schematically illustrating one example of a configuration of an imaging apparatus according to one embodiment of the present invention.

### DESCRIPTION OF THE EMBODIMENTS

Hereinafter, embodiments of an optical system and an imaging apparatus according to the present invention will be described. However, the following optical system and imaging apparatus are one aspect of the optical system and the imaging apparatus according to the present invention, and the optical system and the imaging apparatus according to the present invention are not limited to the following aspect.

### 1. Optical System

### 1-1. Optical Configuration

The optical system according to the present invention includes, in order from an object side, a first lens group having a positive or negative refractive power, and a rear group having a plurality of lens groups. The rear group includes a first focus group having a negative refractive power that moves in an optical axis direction during focusing, a second focus group having a negative refractive power that moves in the optical axis direction during focusing, and at least one lens group P having a positive refractive power between the first focus group and the second focus group. By appropriately configuring the lens group P, downsizing of the optical system can be achieved.

### (1) First Lens Group

The behavior of the first lens group is not limited during focusing, but it is more preferable for the downsizing of the optical system to fix the first lens group with respect to an image plane. It is also preferable that the first lens group includes at least one positive lens, as this facilitates suppression of chromatic aberration and achievement of excellent optical performance. Furthermore, it is more preferable that the first lens group includes at least two positive lenses. In addition, it is preferable that a positive lens is provided at a position closest to the image side within the first focus group, as this suppresses aberration fluctuation during focusing. It is also preferable that the first lens group includes at least one negative lens, as this facilitates suppression of chromatic aberration and achievement of excellent optical performance. It is also preferable that the first lens group includes at least one cemented lens formed of a positive lens and a negative lens, as this facilitates suppression of chromatic aberration and reduction of sensitivity of each lens. Alternatively, it is preferable that the first lens group has a positive refractive power, as this facilitates suppression of various aberrations and downsizing.

Here, the term “lens group” refers to a lens group including one lens or a plurality of adjacent lenses, wherein a spacing between adjacent lens groups changes along the optical axis during focusing. In a case where one lens group includes a plurality of lenses, the distances along the optical axis between the individual lenses included in the one lens group do not change during focusing.

### (2) Rear Group

The rear group includes a plurality of lens groups, and as long as the rear group includes the first focus group, the second focus group, and the lens group P, the specific configuration of the rear group is not particularly limited. A lens group may be configured between the first focus group and the lens group P, and a lens group may also be configured between the second focus group and the lens group P. Further, a lens group may also be configured on the image side of the second focus group. The lens group arranged on the image side of the second focus group may be fixed with respect to the image plane during focusing.

### (3) First Focus Group

The first focus group is a lens group having a negative refractive power, and as long as the first focus group includes at least one lens with a negative refractive power, its specific configuration is not particularly limited. The first focus group may include at least one lens having a positive refractive power and at least one lens having a negative refractive power. Further, it is preferable for downsizing the optical system and the lens barrel that the first focus group includes one lens component (single lens component), which is either a single lens or a cemented lens formed by cementing two or more lenses. Further, it is preferable that the first focus group has a concave surface on the object side.

### (4) Second Focus Group

The second focus group is a lens group having a negative refractive power, and as long as the second focus group includes at least one lens with a negative refractive power, its specific configuration is not particularly limited. The second focus group may include at least one lens having a positive refractive power and at least one lens having a negative refractive power. Further, it is preferable for downsizing the optical system and the lens barrel that the second focus group includes one lens component (single lens component), which is either a single lens or a cemented lens formed by cementing two or more lenses. Further, it is preferable that the second focus group has a concave surface on the object side.

### (5) Lens Group P

The lens group P is disposed between the first focus group and the second focus group, and has a positive refractive power. By appropriately setting the power of the negative subgroup PN, which is disposed at a position closest to the object side within the lens group P, downsizing of the optical system and the lens barrel can be achieved. Other than the configuration of the subgroup PN, the configuration of the lens group P is not particularly limited. It is preferable that the lens group P is fixed with respect to the image plane during focusing.

### (6) Subgroup PN

The subgroup PN is disposed at the position closest to the object side of the lens group P and has a negative power. While the lens configuration of the subgroup PN is not particularly limited, it is preferable that the lens configuration of the subgroup PN includes, in order from the object side, a negative lens and a negative lens; or a negative lens and a positive lens; or a negative lens, a positive lens, and a positive lens; or a negative lens, a positive lens, and a negative lens; or a negative lens, a negative lens, and a positive lens; or a negative lens, a negative lens, and a negative lens. Further, it is more preferable from the viewpoint of downsizing the optical system and the lens barrel that the subgroup PN includes one lens component (single lens component), which is either a single lens or a cemented lens formed by cementing two or more lenses. From the viewpoint of aberration correction, it is preferable that the subgroup PN includes at least one positive lens.

### (7) Aperture Stop

In the optical system, the arrangement of the aperture stop is not particularly limited. Here, “aperture stop” refers to the aperture stop that defines the light beam diameter of the optical system, that is, the aperture stop that defines the Fno of the optical system. However, it is preferable to arrange the aperture stop within the rear group in order to achieve downsizing of a stop unit. Furthermore, it is preferable that when the rear group includes a lens group having a negative refractive power, the aperture stop is arranged on the object side of the lens group having the negative refractive power. In order to cancel negative distortion and negative field curvature generated by a front group, it is sufficient to generate aberrations in the same direction behind and in front of the aperture stop. Therefore, by arranging the aperture stop on the image side of the first lens group and on the object side of the lens group having the negative refractive power within the rear group, the aberrations can be efficiently canceled out by each other behind and in front of the aperture stop, which is preferable for obtaining an optical system with high optical performance.

It is more preferable that the aperture stop is arranged between the first focus group and the second focus group, and it is still more preferable that the aperture stop is arranged behind or in front of the lens group P or within the lens group P. With such a configuration, in a focus state at the minimum object distance, excellent aberration correction can be achieved, thereby enabling the configuration of a high-performance optical system.

### (8) Other Lens

The rear group may include a lens on the image side of the second focus group. From the viewpoint of aberration correction, it is preferable that at least one positive lens is provided on the image side of the second focus group. It is more preferable that at least two positive lenses are provided. Furthermore, from the viewpoint of aberration correction, it is preferable that the optical system has a positive lens at the position closest to the image side. In addition, it is preferable that a lens having a negative refractive power is provided on the image side of the second focus group.

### 1-2. Operation

### (1) Focusing

The optical system is not particularly limited in its specific operation as long as at least the first focus group and the second focus group move along the optical axis when focusing from infinity to a close distance. For example, a configuration in which the first focus group and the second focus group respectively move toward the image side along the optical axis when focusing from infinity to a close distance is preferable. Furthermore, it is more preferable that the first focus group and the second focus group move along the optical axis with different movement amounts during focusing from infinity to a close distance. This configuration makes it possible to achieve higher optical performance from infinity to the minimum object distance. In addition, it is more preferable that, when focusing from infinity to a close distance, the second focus group moves along the optical axis by a greater movement amount with respect to the image plane than the first focus group. This configuration makes it possible to achieve still higher optical performance from infinity to the minimum object distance. Moreover, it is more preferable that the optical system further includes a lens group that moves focusing from infinity to a close distance, in addition to the first focus group and the second focus group. This configuration makes it possible to achieve higher optical performance from infinity to the minimum object distance.

### 1-3. Conditional Formula

With the aforementioned configuration, the optical system preferably satisfies at least one of the following conditional formulae.

1-3-1. Conditional Formula (1)

$$0.3 < \vert fP / fPN \vert \qquad ( 1 )$$

here,
fP is a focal length of the lens group P, and
fPN is a focal length of the subgroup PN.

The aforementioned conditional formula (1) defines the power of the subgroup PN within the lens group P. By satisfying conditional formula (1), it is possible to effectively correct spherical aberration and coma aberration that may occur when reducing the weight of the first focus group.

In contrast, if the value of conditional formula (1) is equal to or less than the lower limit, the correction of spherical aberration and coma aberration is insufficient, making it difficult to achieve high optical performance.

In order to obtain the aforementioned effects, the lower limit of conditional formula (1) is more preferably 0.6, and still more preferably 0.8 or more. Furthermore, the upper limit of conditional formula (1) is preferably 3.0, more preferably 2.0, and still more preferably 1.5. When these preferable lower limits or upper limits are adopted, a strict inequality sign (<) may be replaced with an inequality sign (≤) in conditional formula (1). The same principle applies to other conditional formulae as well.

1-3-2. Conditional Formula (2)

$$0.05 < \vert ( 1 - β f 1 \times β f 1 ) \times β f 1 r \times β f 1 r \vert / Fno < 2. \qquad ( 2 )$$

here,
βf1 is a lateral magnification of the first focus group at infinity focus,
βf1r is a lateral magnification at infinity focus of all lenses arranged on the image side of the first focus group, and
Fno is an open F-number of the optical system at infinity focus.

Conditional the focus formula (2) defines sensitivity of the first focus group. Here, the focus sensitivity refers to the amount of image plane shift relative to the focus movement amount. By satisfying conditional formula (2), it is possible to achieve both downsizing and high performance.

In contrast, if the value of conditional formula (2) is equal to or less than the lower limit, the focus movement amount increases, resulting in an increase in the size of the optical system and the lens barrel. Conversely, if the value of conditional formula (2) is equal to or higher than the upper limit, the focus movement amount can be reduced, which is advantageous for downsizing the optical system and the lens barrel; however, the sensitivity becomes excessively high, making it difficult to control the focusing operation.

In order to obtain the aforementioned effects, it is preferable that the lower limit of conditional formula (2) is 0.1, more preferably 0.3, and still more preferably 0.6. Furthermore, the upper limit of conditional formula (2) is preferably 1.8, and more preferably 1.6.

1-3-3. Conditional Formula (3)

$$0.05 < \vert ( 1 - β f 2 \times β f 2 ) \times β f 2 r \times β f 2 r \vert / Fno < 2. \qquad ( 3 )$$

here,
βf2 is a lateral magnification of the second focus group at infinity focus, and
βf2r is a lateral magnification at infinity focus of all lenses arranged on the image side of the second focus group.

Conditional formula (3) defines the focus sensitivity of the second focus group. By satisfying conditional formula (3), it is possible to achieve both downsizing and high performance.

In contrast, if the value of conditional formula (3) is equal to or less than the lower limit, the focus movement amount increases, resulting in an increase in the size of the optical system and the lens barrel. Conversely, if the value of conditional formula (3) is equal to or higher than the upper limit, the focus movement amount can be reduced, which is advantageous for downsizing the optical system and the lens barrel; however, the sensitivity becomes excessively high, making it difficult to control the focusing operation.

In order to obtain the aforementioned effects, it is preferable that the lower limit of conditional formula (3) is 0.1, more preferably 0.3, and still more preferably 0.6. Furthermore, the upper limit of conditional formula (3) is preferably 1.8, and more preferably 1.6.

1-3-4. Conditional Formula (4)

$$0.1 < fP / f < 2. \qquad ( 4 )$$

here,
f is a focal length of the optical system at infinity focus.

Conditional formula (4) defines the lens group P. By satisfying conditional formula (4), it is possible to achieve both downsizing and high performance.

In contrast, if the value of conditional formula (4) is equal to or less than the lower limit, various aberrations increase, resulting in an increase in size due to the need for their correction. Conversely, if the value of conditional formula (4) is equal to or higher than the upper limit, the converging action of the group P is weaker, resulting in an increase in the size of the optical system.

In order to obtain the aforementioned effects, it is preferable that the lower limit of conditional formula (4) is 0.15, more preferably 0.2, and still more preferably 0.25. Furthermore, the upper limit of conditional formula (4) is preferably 0.9, and more preferably 0.7.

1-3-5. Conditional Formula (5)

$$- 1. < ff 1 / f < - 0.1 \qquad ( 5 )$$

here,
ff1 is a focal length of the first focus group, and
f is a focal length of the optical system at infinity focus.

Conditional formula (5) defines the power of the first focus group. By satisfying conditional formula (5), it is possible to achieve both downsizing and high performance.

In contrast, if the value of conditional formula (5) is equal to or less than the lower limit, the focus movement amount increases, resulting increase in size. Conversely, if the value of conditional formula (5) is equal to or higher than the upper limit, various aberrations increase, resulting in an increase in the size of the optical system due to the need for their correction.

In order to obtain the aforementioned effects, it is preferable that the lower limit of conditional formula (5) is −0.9, more preferably −0.8, and still more preferably −0.7. Furthermore, the upper limit of conditional formula (5) is preferably −0.2, and more preferably −0.3.

1-3-6. Conditional Formula (6)

$$- 1. < ff 2 / f < - 0.1 \qquad ( 6 )$$

here,
ff2 is a focal length of the second focus group, and
f is a focal length of the optical system at infinity focus.

Conditional formula (6) defines the power of the second focus group. By satisfying conditional formula (6), it is possible to achieve both downsizing and high performance.

In contrast, if the value of conditional formula (6) is equal to or less than the lower limit, the focus movement amount increases, resulting in an increase in size. Conversely, if the value of conditional formula (6) is equal to or higher than the upper limit, various aberrations increase, resulting in an increase in the size of the optical system due to the need for their correction.

In order to obtain the aforementioned effects, it is preferable that the lower limit of conditional formula (6) is −0.9, more preferably −0.8, and still more preferably −0.7. Furthermore, the upper limit of conditional formula (6) is preferably −0.2, and more preferably −0.3.

1-3-7. Conditional Formula (7)

$$0.05 < f 1 / f < 1. \qquad ( 7 )$$

here,
f1 is a focal length of the first lens group, and
f is a focal length of the optical system at infinity focus.

Conditional formula (7) defines the power of the first lens group. By satisfying conditional formula (7), it is possible to achieve both downsizing and high performance.

In contrast, if the value of conditional formula (7) is equal to or less than the lower limit, various aberrations increase, resulting in an increase in the size of the optical system due to the need for their correction. Conversely, if the value of conditional formula (7) is equal to or higher than the upper limit, the total optical length is longer, resulting in an increase in the size of the optical system.

In order to obtain the aforementioned effects, it is preferable that the lower limit of conditional formula (7) is 0.1, more preferably 0.2, and still more preferably 0.3. Furthermore, the upper limit of conditional formula (7) is preferably 0.9, and more preferably 0.8.

1-3-8. Conditional Formula (8)

$$- 1. < m 1 / ff 1 < - 0.2 \qquad ( 8 a )$$

$$- 1. < m 2 / ff 2 < - 0.2 \qquad ( 8 b )$$

here,
m1 is a movement amount of the first focus group during focusing from infinity to the minimum object distance,
m2 is a movement amount of the second focus group during focusing from infinity to the minimum object distance,
ff1 is a focal length of the first focus group,
ff2 is a focal length of the second focus group, and
a moving direction from the object side to the image side is positive.

Conditional formulas (8a) and (8b) define the ratios between the powers of the first focus group and the second focus group and their respective movement amounts during focusing from infinity to the minimum object distance. By satisfying conditional formulae (8a) and (8b) simultaneously, it is possible to achieve both downsizing and high performance.

In contrast, if the values of conditional formulae (8a) and (8b) are equal to or less than the lower limit, the focus movement amount increases, resulting in an increase in the size of the optical system. Conversely, if the values of conditional formulae (8a) and (8b) are equal to or higher than the upper limit, various aberrations increase, resulting in an increase in the size of the optical system due to the need for their correction.

In order to obtain the aforementioned effects, it is preferable that the lower limit of conditional formula (8a) is −0.8, more preferably −0.6, and still more preferably −0.5. Furthermore, the upper limit of conditional formula (8a) is preferably −0.21, and more preferably −0.22.

In order to obtain the aforementioned effects, it is preferable that the lower limit of conditional formula (8b) is −0.8, more preferably −0.6, and still more preferably −0.5. Furthermore, the upper limit of conditional formula (8b) is preferably −0.22, and more preferably −0.24.

### 2. Imaging Apparatus

Next, an imaging apparatus according to the present invention will be described. The imaging apparatus according to the present invention includes the optical system according to the present invention and an image sensor that converts an optical image formed by the optical system into an electrical signal. Note that the image sensor is preferably disposed on the image side of the optical system.

Here, the image sensor or the like is not particularly limited and solid-state image sensors such as a Charge Coupled Device (CCD) sensor or a Complementary Metal Oxide Semiconductor (CMOS) sensor can be used. The imaging apparatus according to the present invention is suitable for an imaging apparatus using these solid-state image sensors, such as digital cameras and digital video cameras. In addition, the imaging apparatus can be applied to various imaging apparatuses such as a single lens reflex camera, a mirrorless camera, a digital still camera, a surveillance camera, an in-vehicle camera, and a drone-mounted camera. In addition, these imaging apparatuses may be interchangeable lens imaging apparatuses or may be fixed lens imaging apparatuses in each of which a lens is fixed to a housing. The optical system according to the present invention is particularly suitable for use in an optical system of an imaging apparatus equipped with a large image sensor such as a full-size sensor. Since the optical system is compact and lightweight as a whole and has high optical performance, the optical system is capable of capturing high-quality images even when used as an optical system for such an imaging apparatus.

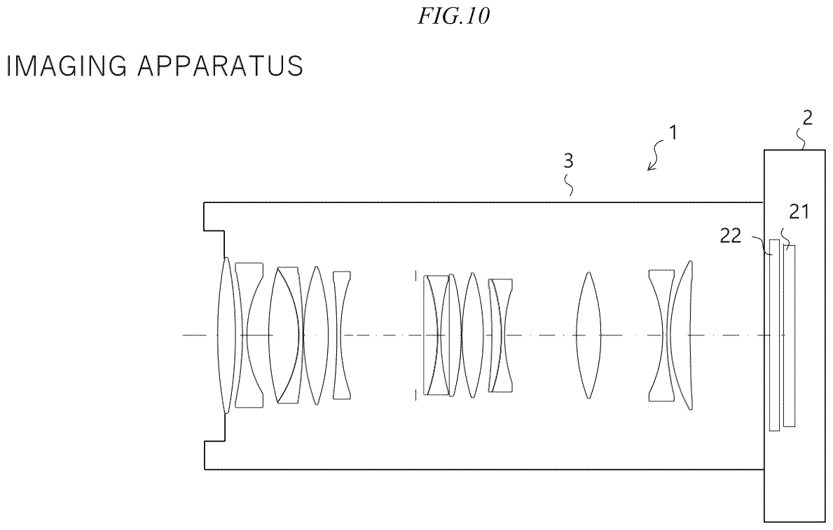

FIG. 10 is a diagram schematically illustrating one example of a configuration of an imaging apparatus according to the present embodiment. As illustrated in FIG. 10, an imaging apparatus 1 includes a camera 2 and a lens 3 detachable from the camera 2. The imaging apparatus 1 is an aspect of an imaging apparatus. The camera 2 includes a CCD sensor 21 as an image sensor and a cover glass 22. The CCD sensor 21 is arranged in the camera 2 at a position where the optical axis of the lens in the lens 3 attached to the camera 2 is the central axis. The camera 2 may include an IR cut filter or the like instead of the cover glass 22. The camera 2 may include a CMOS sensor instead of the CCD sensor 21.

Next, the present invention will be specifically described with reference to examples. However, the present invention is not limited to the following examples.

### Example 1

### (1) Optical Configuration

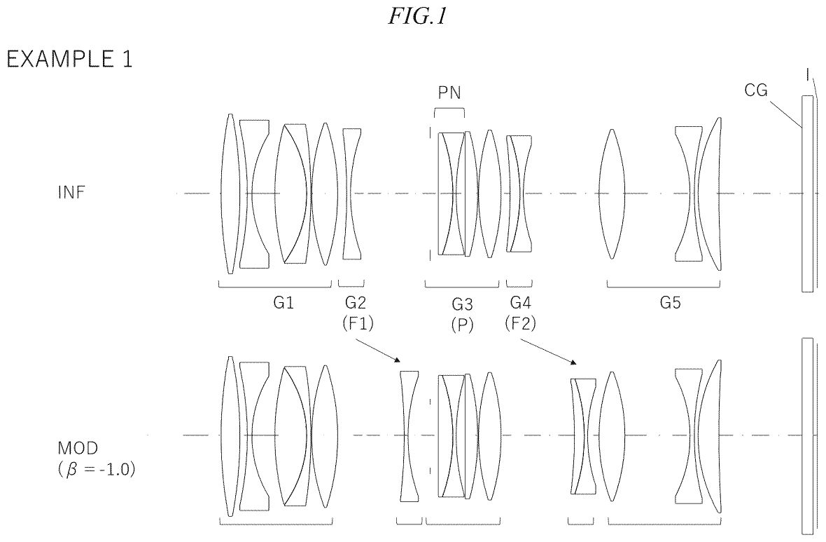

FIG. 1 illustrates a lens cross-sectional view of an optical system according to Example 1. As illustrated in FIG. 1, the optical system includes, in order from the object side, a first lens group G1 having a positive refractive power, and a rear group having a plurality of lens groups. The rear group includes, in order from the object side, a second lens group G2 (first focus group) having a negative refractive power, a third lens group G3 (lens group P) having a positive refractive power, a fourth lens group (second focus group) having a negative refractive power, and a fifth lens group having a positive refractive power.

During focusing from infinity to the minimum object distance, the first focus group moves toward the image side, and the second focus group moves toward the image side. The configurations of the respective lens groups are described below.

The first lens group G1 includes, in order from the object side, a biconvex lens, a biconcave lens, a cemented lens formed by cementing a biconvex lens and a negative meniscus lens having a concave surface facing the object side, and a biconvex lens.

The second lens group G2 includes a biconcave lens.

The third lens group G3 includes, in order from the object side, an aperture stop, a cemented lens formed by cementing a biconvex lens and a biconcave lens, a positive meniscus lens having a concave surface facing the object side, and a biconvex lens. Here, the subgroup PN includes the cemented lens which is located at the position closest to the object side.

The fourth lens group G4 includes, in order from the object side, a cemented lens formed by cementing a positive meniscus lens having a concave surface facing the object side and a biconcave lens.

The fifth lens group G5 includes, in order from the object side, a biconvex lens, a biconcave lens, and a positive meniscus lens having a convex surface facing the object side.

In FIG. 1, “I” indicates the image plane, and specifically indicates an imaging surface of a solid-state image sensor such as a CCD sensor or a CMOS sensor, a film surface such as a silver halide film, or the like. A cover glass CG or the like is provided on the object side of the image plane. This also applies to the lens cross-sectional views illustrated in other examples, and thus, the description thereof will be omitted hereinafter.

### (2) Numerical Examples

Next, numerical examples which adopt detailed numerical values of the optical system will be described. Hereinafter, “lens data”, “specification table”, “variable interval”, and “lens group data” are illustrated. In addition, values of each conditional formula (Table 1) are collectively illustrated after Example 3.

In the “lens data”, “surface number” indicates an order of the lens surface counted from the object side, “R” indicates a curvature radius of a lens surface, “D” indicates a lens thickness or an air interval on the optical axis, “Nd” indicates a refractive index at a d-line (wavelength λ=587.56 nm), and “ABV” indicates an Abbe number at the d-line. In the “surface number” column, “STOP” following a surface number indicates that the surface corresponds to an aperture stop. In the “D” column, “D(9)” or “D(11)” and the like indicate that the interval on the optical axis of the lens surface is a variable interval that changes at a time of magnification change. In addition, “0.0000” in the column of curvature radius indicates infinity, and indicates that the lens surface is a flat surface.

In the “specification table”, “f” indicates a focal length of the optical system, “Fno” indicates an F-number, “@” indicates a half angle of view, and “Y” indicates an image height. Each value is indicated for the case of infinity focus and for the case of minimum object distance (MOD) focus.

The “variable interval” indicates values which are respectively for the case of infinity focus and for the case of minimum object distance focus. The same applies to other examples. Here, an imaging distance indicates a distance from the image plane.

The items in each of these tables also apply to the tables shown in other examples, and thus, the description thereof will be omitted hereinafter.

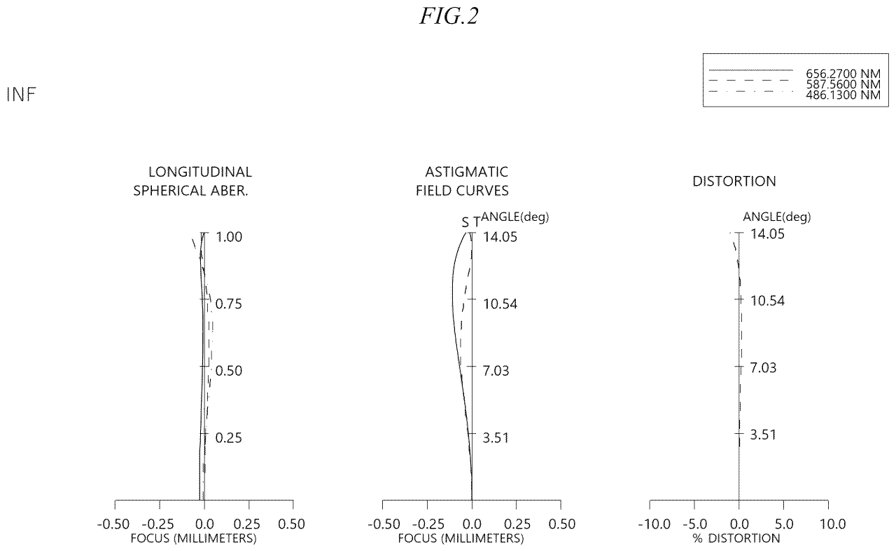

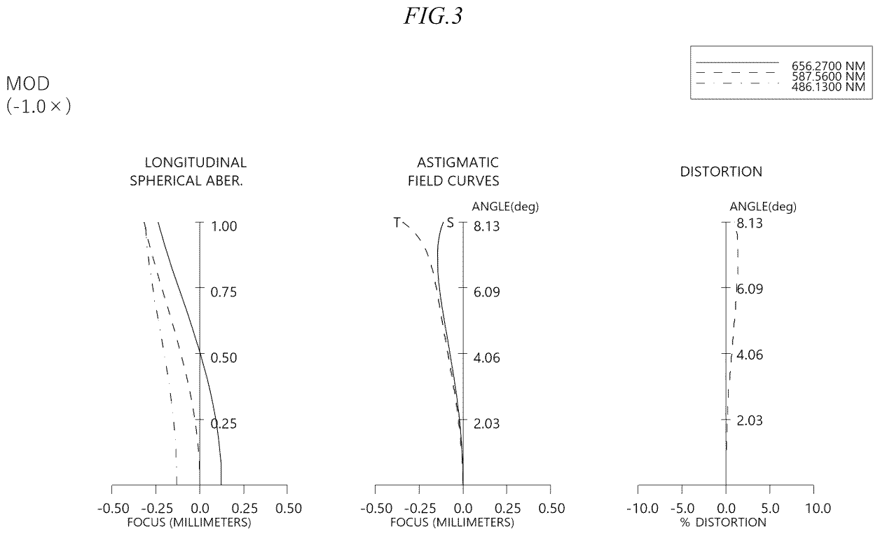

Moreover, FIGS. 2 and 3 are longitudinal aberration diagrams of the optical system at infinity focus and at minimum object distance focus, respectively. The longitudinal aberration diagrams illustrated in each figure are, from the left side of the drawing, spherical aberration (mm), astigmatism (mm), and distortion aberration (%). In the spherical aberration diagram, a solid line indicates spherical aberration at a C-line (wavelength: 656.27 nm), a broken line indicates spherical aberration at the d-line (wavelength: 587.56 nm), and a dash-dot line indicates spherical aberration at an F-line (wavelength: 486.13 nm). In the astigmatism diagram, the vertical axis indicates the half angle of view (ω), the horizontal axis indicates a defocus, the solid line indicates a sagittal image plane(S) of the d-line, and the broken line indicates a meridional image plane (T) of the d-line. In the distortion aberration diagram, the vertical axis indicates the half angle of view (ω), and the horizontal axis indicates distortion aberration. These items also apply to each aberration diagram shown in other examples, and thus, the description thereof will be omitted hereinafter.

(Lens data)

| Surface number | R | D | Nd | ABV |
|---|---|---|---|---|
| 1 | 100.1350 | 4.3798 | 1.92119 | 23.96 |
| 2 | −98.6318 | 1.7173 | | |
| 3 | −75.3119 | 1.1000 | 1.58913 | 61.25 |
| 4 | 26.9027 | 5.3372 | | |
| 5 | 60.8824 | 7.3949 | 1.59282 | 68.62 |
| 6 | −27.0778 | 1.0000 | 1.85451 | 25.15 |
| 7 | −108.4941 | 0.2000 | | |
| 8 | 48.0920 | 6.0449 | 1.59282 | 68.62 |
| 9 | −53.7047 | D(9) | | |
| 10 | −124.3739 | 0.9000 | 1.59349 | 67.00 |
| 11 | 41.8731 | D(11) | | |
| 12STOP | 0.0000 | 2.0000 | | |
| 13 | −4147.1302 | 3.3000 | 1.49700 | 81.61 |
| 14 | −42.1546 | 0.8000 | 1.80809 | 22.76 |
| 15 | 50.4880 | 2.0585 | | |
| 16 | −2099.2589 | 2.9563 | 1.89286 | 20.36 |
| 17 | −56.7699 | 0.2000 | | |
| 18 | 49.6082 | 5.2402 | 1.75500 | 52.32 |
| 19 | −49.6082 | D(19) | | |
| 20 | −105.2889 | 2.3000 | 1.86966 | 20.02 |
| 21 | −41.7558 | 0.8000 | 1.69680 | 55.53 |
| 22 | 35.9595 | D(22) | | |
| 23 | 42.7870 | 6.0298 | 1.43700 | 95.10 |
| 24 | −42.7870 | 15.1674 | | |
| 25 | −30.1667 | 1.0000 | 1.71300 | 53.94 |
| 26 | 58.2877 | 0.8918 | | |
| 27 | 35.8576 | 4.8483 | 1.48749 | 70.44 |
| 28 | 284.4302 | 19.4558 | | |
| 29 | 0.0000 | 2.5000 | 1.51633 | 64.14 |
| 30 | 0.0000 | 1.0000 | | |
| Image plane | 0.0000 | | | |

(Specification table)

| | INF | MOD |
|---|---|---|
| f | 87.3000 | 38.8752 |
| Fno | 2.9093 | 5.8166 |
| ω | 14.0522 | 8.1250 |
| Y | 21.633 | 21.633 |

(Variable interval)

| | | |
|---|---|---|
| Imaging distance | INF | 227.4085 |
| D(9) | 2.1000 | 15.5002 |
| D(11) | 18.5258 | 5.1255 |
| D(19) | 2.1000 | 17.1003 |
| D(22) | 17.6506 | 2.6500 |

(Lens group data)

| Group | Surface number | Focal length |
|---|---|---|
| G1 | 1-9 | 47.3434 |
| G2 | 10-11 | −52.6768 |
| G3 | 13-19 | 38.6246 |
| G4 | 20-22 | −42.2133 |
| G5 | 23-28 | 228.7960 |

### Example 2

### (1) Optical Configuration

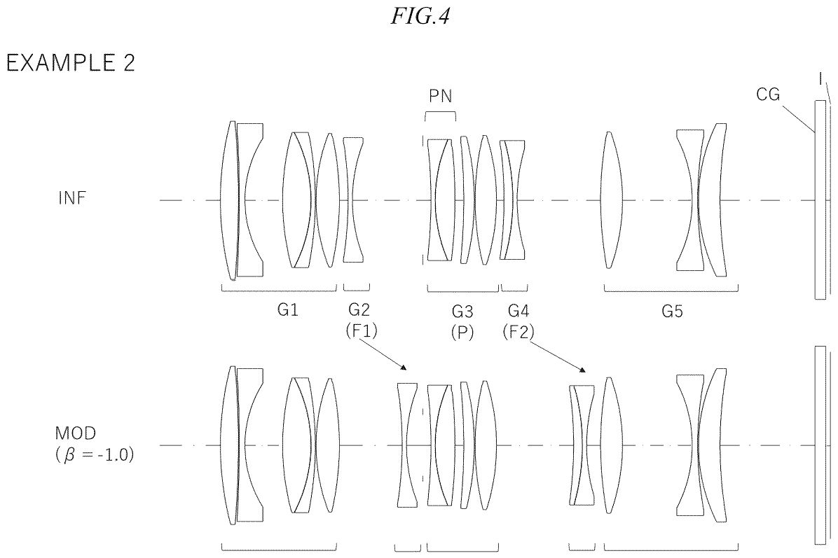

FIG. 4 illustrates a lens cross-sectional view of an optical system according to Example 2. As illustrated in FIG. 4, the optical system includes, in order from the object side, a first lens group G1 having a positive refractive power, and a rear group having a plurality of lens groups. The rear group includes, in order from the object side, a second lens group G2 (first focus group) having a negative refractive power, a third lens group G3 (lens group P) having a positive refractive power, a fourth lens group (second focus group) having a negative refractive power, and a fifth lens group having a positive refractive power.

During focusing from infinity to the minimum object distance, a first focus group F1 moves toward the image side, and a second focus group F2 moves toward the image side. The configurations of the respective lens groups are described below.

The first lens group G1 includes, in order from the object side, a biconvex lens, a biconcave lens, a cemented lens formed by cementing a biconvex lens and a negative meniscus lens having a concave surface facing the object side, and a biconvex lens.

The second lens group G2 also includes a biconcave lens.

The third lens group G3 includes, in order from the object side, an aperture stop, a cemented lens formed by cementing a biconcave lens and a biconvex lens, a positive meniscus lens having a concave surface facing the object side, and a biconvex lens. Here, the subgroup PN includes the cemented lens which is located at the position closest to the object side.

The fourth lens group G4 includes, in order from the object side, a cemented lens formed by cementing a positive meniscus lens having a concave surface facing the object side and a biconcave lens.

The fifth lens group G5 includes, in order from the object side, a biconvex lens, a biconcave lens, and a positive meniscus lens having a convex surface facing the object side.

### (2) Numerical Examples

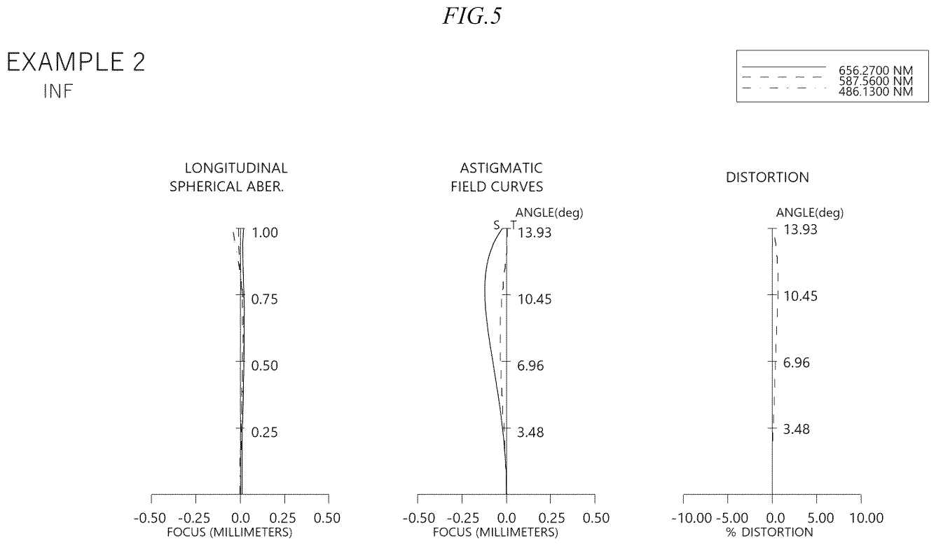

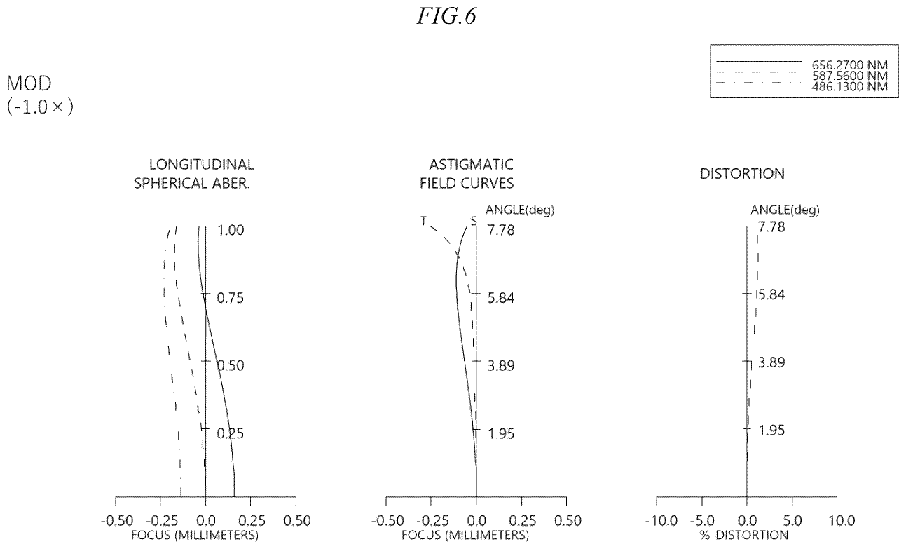

Next, numerical examples to which specific numerical values of the optical system are applied will be described. Moreover, FIGS. 5 and 6 are longitudinal aberration diagrams of the optical system at infinity focus and at minimum object distance focus, respectively.

(Lens data)

| Surface number | R | D | Nd | ABV |
|---|---|---|---|---|
| 1 | 71.5589 | 4.1210 | 1.92119 | 23.96 |
| 2 | −219.5042 | 0.2004 | | |
| 3 | −293.7763 | 1.3000 | 1.49700 | 81.61 |
| 4 | 26.5081 | 8.6424 | | |
| 5 | 58.0026 | 6.4801 | 1.49700 | 81.61 |
| 6 | −33.2115 | 1.0000 | 1.92286 | 20.88 |
| 7 | −79.1808 | 0.2000 | | |
| 8 | 42.0817 | 5.3301 | 1.49700 | 81.61 |
| 9 | −68.0747 | D(9) | | |
| 10 | −87.1892 | 1.0000 | 1.59349 | 67.00 |
| 11 | 36.2811 | D(11) | | |
| 12STOP | 0.0000 | 1.8241 | | |
| 13 | −119.2121 | 1.0000 | 1.85451 | 25.15 |
| 14 | 34.6920 | 4.5239 | 1.43700 | 95.10 |
| 15 | −116.3563 | 2.0044 | | |
| 16 | −141.1644 | 2.4170 | 1.92286 | 20.88 |
| 17 | −59.1152 | 0.2000 | | |
| 18 | 61.2811 | 4.9001 | 1.75500 | 52.32 |
| 19 | −48.4537 | D(19) | | |
| 20 | −93.9014 | 2.0000 | 1.92286 | 20.88 |
| 21 | −49.8638 | 1.0000 | 1.67790 | 55.35 |
| 22 | 41.6734 | D(22) | | |
| 23 | 85.7772 | 5.0026 | 1.59349 | 67.00 |
| 24 | −46.2418 | 15.9953 | | |
| 25 | −31.0227 | 1.2491 | 1.75500 | 52.32 |
| 26 | 79.6879 | 0.2000 | | |
| 27 | 39.4153 | 4.9393 | 1.73400 | 51.47 |
| 28 | 99.6712 | 21.7980 | | |
| 29 | 0.0000 | 2.5000 | 1.51633 | 64.14 |
| 30 | 0.0000 | 1.0000 | | |
| Image plane | 0.0000 | | | |

(Specification table)

| | INF | MOD |
|---|---|---|
| F | 87.1571 | 40.3979 |
| Fno | 2.9100 | 5.8200 |
| ω | 13.9280 | 7.7952 |
| Y | 21.633 | 21.633 |

(Variable interval)

| | | |
|---|---|---|
| Imaging distance | INF | 226.4085 |
| D(9) | 2.0000 | 14.4077 |
| D(11) | 16.1682 | 3.7606 |
| D(19) | 1.7339 | 17.6759 |
| D(22) | 19.1433 | 3.2013 |

(Lens group data)

| Group | Surface number | Focal length |
|---|---|---|
| G1 | 1-9 | 44.3441 |
| G2 | 10-11 | −43.0385 |
| G3 | 13-19 | 38.3126 |
| G4 | 20-22 | −46.8480 |
| G5 | 23-28 | 215.7390 |

### Example 3

### (1) Optical Configuration

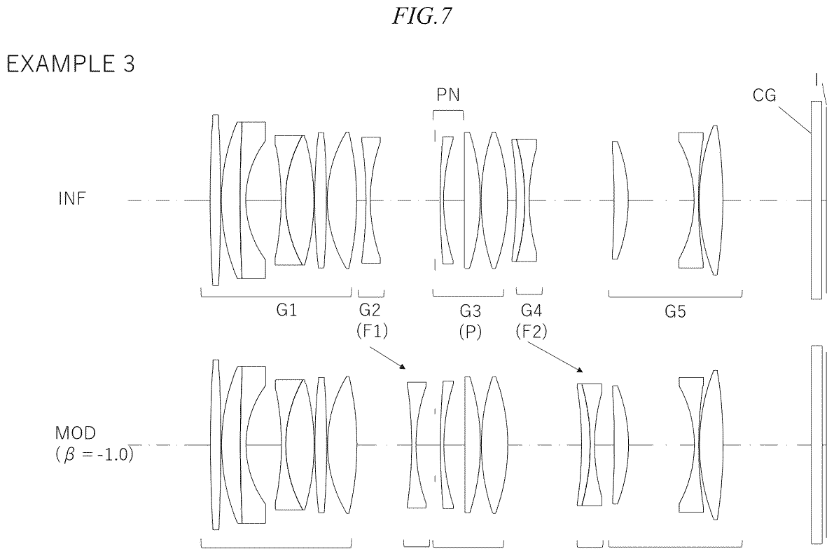

FIG. 7 illustrates a lens cross-sectional view of an optical system according to Example 3. As illustrated in FIG. 7, the optical system includes a first lens group G1 having a positive refractive power and a rear group having a plurality of lens groups. The rear group includes, in order from the object side, a second lens group G2 (first focus group) having a negative refractive power, a third lens group G3 (lens group P) having a positive refractive power, a fourth lens group (second focus group) having a negative refractive power, and a fifth lens group having a negative refractive power.

During focusing from infinity to the minimum object distance, a first focus group F1 moves toward the image side, and a second focus group moves toward the image side. The configurations of the respective lens groups are described below.

The first lens group G1 includes, in order from the object side, a biconvex lens, a cemented lens formed by cementing a positive meniscus lens having a convex surface facing the object side and a negative meniscus lens having a convex surface facing the object side, a cemented lens formed by cementing a negative meniscus lens having a concave surface facing the object side and a biconvex lens, a biconvex lens, another biconvex lens.

The second lens group G2 includes a biconcave lens.

The third lens group G3 includes, in order from the object side, an aperture stop, a negative meniscus lens having a convex surface facing the object side, a positive meniscus lens having a concave surface facing the object side, and a biconvex lens. Here, the subgroup PN includes the negative meniscus lens which is located at the position closest to the object side.

The fourth lens group G4 includes, in order from the object side, a cemented lens formed by cementing a positive meniscus lens having a concave surface facing the object side and a biconcave lens.

The fifth lens group G5 includes, in order from the object side, a biconvex lens, a biconcave lens, and another biconvex lens.

### (2) Numerical Examples

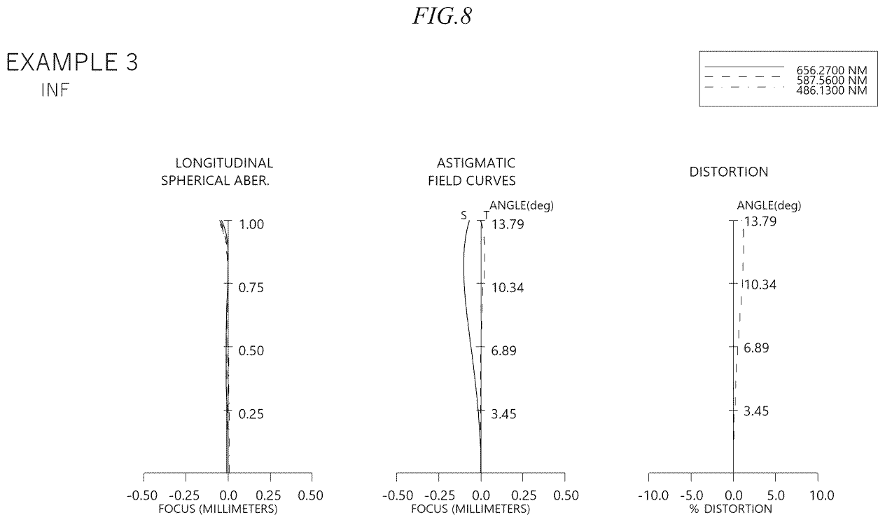

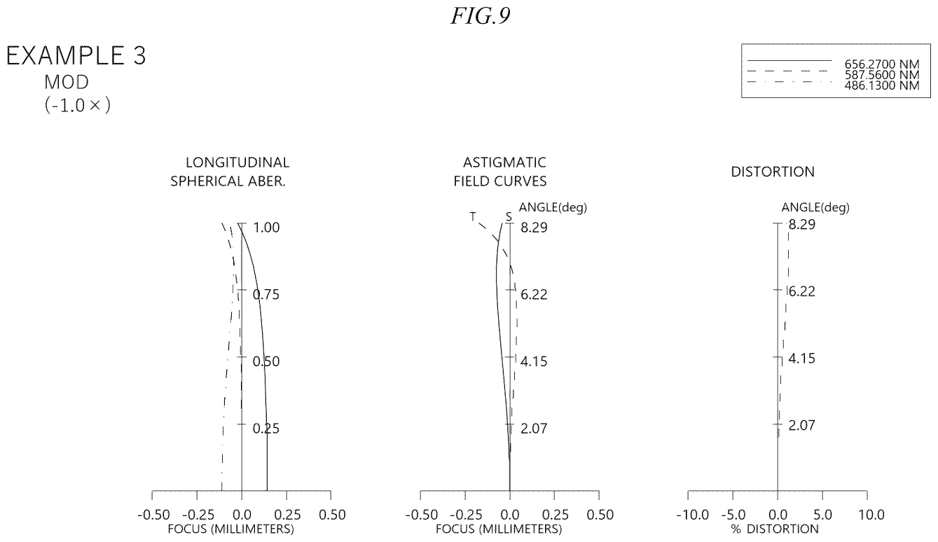

Next, numerical examples to which specific numerical values of the optical system are applied will be described. Moreover, FIGS. 8 and 9 are longitudinal aberration diagrams of the optical system at infinity focus and at minimum object distance focus, respectively.

(Lens data)

| Surface number | R | D | Nd | ABV |
|---|---|---|---|---|
| 1 | 328.0375 | 2.3837 | 1.84666 | 23.78 |
| 2 | −443.5133 | 0.2000 | | |
| 3 | 46.4243 | 4.3180 | 1.92286 | 20.88 |
| 4 | 384.4079 | 1.3000 | 1.49700 | 81.61 |
| 5 | 22.9260 | 8.1557 | | |
| 6 | −64.2191 | 1.0000 | 1.84666 | 23.78 |
| 7 | 30.5205 | 6.5259 | 1.49700 | 81.61 |
| 8 | −53.1204 | 0.2140 | | |
| 9 | 146.9022 | 2.6972 | 1.95375 | 32.32 |
| 10 | −211.4652 | 0.2000 | | |
| 11 | 30.4009 | 6.7703 | 1.49700 | 81.61 |
| 12 | −68.7349 | D(12) | | |
| 13 | −98.1191 | 1.0000 | 1.80420 | 46.50 |
| 14 | 40.1255 | D(14) | | |
| 15STOP | 0.0000 | 1.2000 | | |
| 16 | 175.5201 | 0.8000 | 1.92286 | 20.88 |
| 17 | 45.8212 | 4.8715 | | |
| 18 | −1753.0653 | 3.5427 | 1.91082 | 35.25 |
| 19 | −51.2594 | 0.2371 | | |
| 20 | 49.0287 | 6.0726 | 1.59282 | 68.62 |
| 21 | −45.4303 | D(21) | | |
| 22 | −93.6428 | 2.0000 | 1.92286 | 20.88 |
| 23 | −51.4215 | 1.0000 | 1.65160 | 58.54 |
| 24 | 43.8768 | D(24) | | |
| 25 | −205.9687 | 3.2710 | 1.57501 | 41.50 |
| 26 | −37.7312 | 15.1693 | | |
| 27 | −28.0849 | 1.0000 | 1.80420 | 46.50 |
| 28 | 93.9401 | 0.2000 | | |
| 29 | 46.5640 | 5.4341 | 1.59282 | 68.62 |
| 30 | −112.0570 | 20.3384 | | |
| 31 | 0.0000 | 2.5000 | 1.51633 | 64.14 |
| 32 | 0.0000 | 1.0000 | | |
| Image plane | 0.0000 | | | |

(Specification table)

| | INF | MOD |
|---|---|---|
| F | 87.2985 | 40.7664 |
| Fno | 2.9100 | 5.8200 |
| ω | 13.7866 | 78.2947 |
| Y | 21.633 | 21.633 |

(Variable interval)

| | | |
|---|---|---|
| Imaging distance | INF | 219.9901 |
| D(13) | 2.1560 | 12.6172 |
| D(15) | 14.8866 | 4.4255 |
| D(22) | 2.0000 | 16.9999 |
| D(25) | 19.5559 | 4.5559 |

(Lens group data)

| Group | Surface number | Focal length |
|---|---|---|
| G1 | 1-12 | 41.8265 |
| G2 | 13-14 | −35.2992 |
| G3 | 16-21 | 32.4073 |
| G4 | 22-24 | −51.1001 |
| G5 | 25-30 | −351.0320 |

TABLE 1

| | | Example 1 | Example 2 | Example 3 |
|---|---|---|---|---|
| Conditional | \|fP/fPN\| | 0.910 | 0.584 | 0.481 |
| Formula (1) | | | | |
| Conditional | \|(1 − βf1 × βf1) × | | | |
| Formula (2) | βf1r × βf1r\|/Fno | | | |
| | | 1.124 | 1.301 | 1.492 |
| Conditional | \|(1 − βf2 × βf2) × | | | |
| Formula (3) | βf2r × βf2r\|/Fno | | | |
| | | 1.413 | 1.236 | 1.492 |
| Conditional | fp/f | 0.442 | 0.437 | 0.371 |
| Formula (4) | | | | |
| Conditional | ff1/f | −0.603 | −0.493 | −0.404 |
| Formula (5) | | | | |
| Conditional | ff2/f | −0.537 | −0.535 | −0.585 |
| Formula (6) | | | | |
| Conditional | f1/f | 0.542 | 0.506 | 0.479 |
| Formula (7) | | | | |
| Conditional | m1/ff1 | −0.254 | −0.287 | −0.296 |
| Formula (8a) | | | | |
| Conditional | m2/ff2 | −0.320 | −0.340 | −0.294 |
| Formula (8b) | | | | |
| Conditional | β | −1.0 | −1.0 | −1.0 |
| Formula (9) | | | | |

### SUMMARY

An optical system according to a first aspect of the present invention includes:
a first lens group; and a rear group that has a plurality of lens groups, the first lens group and the rear group being arranged in order from an object side, wherein
during focusing, a spacing between lens groups which are adjacent to each other changes,
the rear group includes a first focus group which has a negative refractive power and moves during focusing, and a second focus group which has a negative refractive power and moves during focusing,
at least one lens group P having a positive refractive power is provided between the first focus group and the second focus group,
the lens group P includes a subgroup PN having a negative refractive power at a position closest to the object side, and
following formulae may be satisfied:

$$0.3 < \vert fP / fPN \vert \qquad ( 1 )$$

$$0.05 < \vert ( 1 - β f 1 \times β f 1 ) \times β f 1 r \times β f 1 r / Fno < 2. \qquad ( 2 )$$

here,
fP is a focal length of the lens group P,
fPN is a focal length of the subgroup PN,
βf1 is a lateral magnification of the first focus group at infinity focus,
βf1r is a lateral magnification at infinity focus of all lenses arranged on an image side of the first focus group, and
Fno is an open F-number of the optical system at infinity focus.

An optical system according to a second aspect of the present invention is the optical system according to the first aspect of the present invention, wherein
a following formula may be satisfied:

$$0.05 < \vert ( 1 - β f 2 \times β f 2 ) \times β f 2 r \times β f 2 r \vert / Fno < 2. \qquad ( 3 )$$

here,
βf2 is a lateral magnification of the second focus group at infinity focus, and
βf2r is a lateral magnification at infinity focus of all lenses arranged on an image side of the second focus group.

An optical system according to a third aspect of the present invention is the optical system according to the first aspect or the second aspect of the present invention, wherein
a following formula may be satisfied:

$$0.1 < fP / f < 2. \qquad ( 4 )$$

here,
f is a focal length of the optical system at infinity focus.

An optical system according to a fourth aspect of the present invention is the optical system according to any one of the first to the third aspects of the present invention, wherein
a following formula may be satisfied:

$$- 1. < ff 1 / f < - 0.1 \qquad ( 5 )$$

here,
ff1 is a focal length of the first focus group, and
f is a focal length of the optical system at infinity focus.

An optical system according to a fifth aspect of the present invention is the optical system according to any one of the first to the fourth aspects of the present invention, wherein
a following formula may be satisfied:

$$- 1. < ff 2 / f < - 0.1 \qquad ( 6 )$$

here,
ff2 is a focal length of the second focus group, and
f is a focal length of the optical system at infinity focus.

An optical system according to a sixth aspect of the present invention is the optical system according to any one of the first to the fifth aspects of the present invention, wherein
the first lens group has a positive refractive power, and
a following formula may be satisfied:

$$0.05 < f 1 / f < 1. \qquad ( 7 )$$

here,
f1 is a focal length of the first lens group, and
f is a focal length of the optical system at infinity focus.

An optical system according to a seventh aspect of the present invention is the optical system according to any one of the first to the sixth aspects of the present invention, wherein
the first focus p and the second focus group respectively move toward the image side during focusing from infinity to a minimum object distance, and
following formulae may be satisfied:

$$- 1. < m 1 / ff 1 < - 0.2 \qquad ( 8 a )$$

$$- 1. < m 2 / ff 2 < - 0.2 \qquad ( 8 b )$$

here,
m1 is a movement amount of the first focus group during focusing from infinity to the minimum object distance,
m2 is a movement amount of the second focus group during focusing from infinity to the minimum object distance,
ff1 is a focal length of the first focus group,
ff2 is a focal length of the second focus group, and
a moving direction from the object side to the image side is positive.

An optical system according to an eighth aspect of the present invention is the optical system according to any one of the first to the seventh aspects of the present invention, wherein
the subgroup PN may include a single lens or a cemented lens formed by cementing two or more lenses.

An optical system according to a ninth aspect of the present invention is the optical system according to any one of the first to the eighth aspects of the present invention, wherein
the first focus group may include a single lens or a cemented lens formed by cementing two or more lenses.

An optical system according to a tenth aspect of the present invention is the optical system according to any one of the first to the ninth aspects of the present invention, wherein
the second focus group may include a single lens or a cemented lens formed by cementing two or more lenses.

An imaging apparatus according to an eleventh aspect of the present invention may include the optical system according to any one of the first to the tenth aspects of the present invention, and an image sensor that is provided on an image side of the optical system and converts an optical image formed by the optical system into an electrical signal.

The optical system and the imaging apparatus described in the above embodiments and examples are one aspect of the optical system and the imaging apparatus according to the present invention, and correspond to the optical system according to any one of the first to the tenth aspects of the present invention and the imaging apparatus according to the eleventh aspect of the present invention. According to the optical system and the imaging apparatus of each aspect described above, operational effects similar to the operational effects described in the above embodiments and examples are obtained. The optical system and the imaging apparatus according to the present invention are not limited to the optical system and the imaging apparatus described in the embodiments and the examples, and can be appropriately changed within the scope of the optical system and the imaging apparatus of each aspect described above.

### INDUSTRIAL APPLICABILITY

The optical system according to the present invention can be suitably applied as, for example, an imaging optical system of an imaging apparatus such as a film camera, a digital still camera, or a digital video camera.

1. An optical system comprising:
a first lens group; and
a rear group that has a plurality of lens groups,
the first lens group and the rear group being arranged in order from an object side, wherein
the rear group includes a first focus group which has a negative refractive power and moves during focusing, and a second focus group which has a negative refractive power and moves during focusing,
at least one lens group P having a positive refractive power is provided between the first focus group and the second focus group,
the lens group P includes a subgroup PN having a negative refractive power at a position closest to the object side, and
following formulae are satisfied:
$$0.3 < \vert fP / fPN \vert \qquad ( 1 )$$
$$0.05 < \vert ( 1 - β f 1 \times β f 1 ) \times β f 1 r \times β f 1 r / Fno < 2. \qquad ( 2 )$$
here,
fP is a focal length of the lens group P,
fPN is a focal length of the subgroup PN,
βf1 is a lateral magnification of the first focus group at infinity focus,
βf1r is a lateral magnification at infinity focus of all lenses arranged on an image side of the first focus group, and
Fno is an open F-number of the optical system at infinity focus.

2. The optical system according to claim 1 satisfying a following conditional formula:
$$0.05 < \vert ( 1 - β f 2 \times β f 2 ) \times β f 2 r \times β f 2 r \vert / Fno < 2. \qquad ( 3 )$$
here,
βf2 is a lateral magnification of the second focus group at infinity focus, and
βf2r is a lateral magnification at infinity focus of all lenses arranged on an image side of the second focus group.

3. The optical system according to claim 1 satisfying a following conditional formula:
$$0.1 < fP / f < 2. \qquad ( 4 )$$
here,
f is a focal length of the optical system at infinity focus.

4. The optical system according to claim 1 satisfying a following conditional formula:
$$- 1. < ff 1 / f < - 0.1 \qquad ( 5 )$$
here,
ff1 is a focal length of the first focus group, and
f is a focal length of the optical system at infinity focus.

5. The optical system according to claim 1 satisfying a following conditional formula:
$$- 1. < ff 2 / f < - 0.1 \qquad ( 6 )$$
here,
ff2 is a focal length of the second focus group, and
f is a focal length of the optical system at infinity focus.

6. The optical system according to claim 1, wherein
the first lens group has a positive refractive power, and
a following formula is satisfied:
$$0.05 < f 1 / f < 1. \qquad ( 7 )$$
here,
f1 is a focal length of the first lens group, and
f is a focal length of the optical system at infinity focus.

7. The optical system according to claim 1, wherein
the first focus group and the second focus group respectively move toward the image side during focusing from infinity to a minimum object distance, and
following formulae are satisfied:
$$- 1. < m 1 / ff 1 < - 0.2 \qquad ( 8 a )$$
$$- 1. < m 2 / ff 2 < - 0.2 \qquad ( 8 b )$$
here,
m1 is a movement amount of the first focus group during focusing from infinity to the minimum object distance,
m2 is a movement amount of the second focus group during focusing from infinity to the minimum object distance,
ff1 is a focal length of the first focus group,
ff2 is a focal length of the second focus group, and
a moving direction from the object side to the image side is positive.

8. The optical system according to claim 1, wherein
the subgroup PN includes a single lens or a cemented lens formed by cementing two or more lenses.

9. The optical system according to claim 1, wherein
the first focus group includes a single lens or a cemented lens formed by cementing two or more lenses.

10. The optical system according to claim 1, wherein
the second focus group includes a single lens or a cemented lens formed by cementing two or more lenses.

11. An imaging apparatus comprising:
the optical system according to claim 1, and
a solid-state image sensor that converts an optical image formed by the optical system into an electrical signal.

12. An imaging apparatus comprising:
the optical system according to claim 2, and
a solid-state image sensor that converts an optical image formed by the optical system into an electrical signal.

13. An imaging apparatus comprising:
the optical system according to claim 3, and
a solid-state image sensor that converts an optical image formed by the optical system into an electrical signal.

14. An imaging apparatus comprising:
the optical system according to claim 4, and
a solid-state image sensor that converts an optical image formed by the optical system into an electrical signal.

15. An imaging apparatus comprising:
the optical system according to claim 5, and
a solid-state image sensor that converts an optical image formed by the optical system into an electrical signal.

16. An imaging apparatus comprising:
the optical system according to claim 6, and
a solid-state image sensor that converts an optical image formed by the optical system into an electrical signal.

17. An imaging apparatus comprising:
the optical system according to claim 7, and
a solid-state image sensor that converts an optical image formed by the optical system into an electrical signal.

18. An imaging apparatus comprising:
the optical system according to claim 8, and
a solid-state image sensor that converts an optical image formed by the optical system into an electrical signal.

19. An imaging apparatus comprising:
the optical system according to claim 9, and
a solid-state image sensor that converts an optical image formed by the optical system into an electrical signal.

20. An imaging apparatus comprising:
the optical system according to claim 10, and
a solid-state image sensor that converts an optical image formed by the optical system into an electrical signal.
